(19) United States
(12) Patent Application Publication
(10) Pub. No.: US 2023/0318041 A1
(43) Pub. Date: Oct. 5, 2023

(54) ELECTROLYTIC SOLUTION FOR LITHIUM METAL BATTERY

(71) Applicant: HONDA MOTOR CO., LTD., Tokyo (JP)

(72) Inventors: Ken BABA, Saitama (JP); Takeshi FUJINO, Saitama (JP); Tomohiro KINOSHITA, Saitama (JP)

(21) Appl. No.: 18/183,962

(22) Filed: Mar. 15, 2023

(30) Foreign Application Priority Data
Mar. 31, 2022 (JP) 2022-058113

(51) Int. Cl. H01M 10/0569; H01M 10/0568; H01M 10/0567

(52) U.S. Cl. CPC H01M 10/0569; H01M 10/0568; H01M 10/0567; H01M 2300/0037

(57) ABSTRACT

To provide an electrolytic solution for lithium metal battery, which is capable of reducing the concentration of an electrolyte salt in an electrolytic solution and is excellent in safety and durability during charging/discharging. Disclosed is an electrolytic solution for lithium metal battery, comprising an organic solvent and an electrolyte salt, the electrolyte salt comprising a lithium salt, and the organic solvent comprising a first organic solvent having a vapor pressure at 25° C. of 0.003 MPa or more and having no flash point, and a second organic solvent having a vapor pressure at 25° C. of 0.007 MPa or less.

This application is based on and claims the benefit of priority from Japanese Patent Application No. 2022-058113, filed on 31 Mar. 2022, the content of which is incorporated herein by reference.

### BACKGROUND OF THE INVENTION

### Field of the Invention

The present invention relates to an electrolytic solution for lithium metal battery.

### Related Art

In recent years, research and development have been carried out on secondary batteries which contribute to energy efficiency in order to ensure that many more people have access to affordable, reliable, sustainable and advanced energy. As the secondary battery, a lithium metal battery in which lithium metal is utilized as a negative electrode has attracted attention.

As the lithium metal battery is charged/discharged, lithium may precipitate on the negative electrode and undergo porosification while forming dendrites, leading to deterioration of the battery performance. There has been known, as the technique to suppress porosification, a technique to increase the concentration of an electrolyte salt (see, for example, Patent Document 1).

Patent Document 1: Japanese Unexamined Patent Application (Translation of PCT Application), Publication No. 218-505538

### SUMMARY OF THE INVENTION

An electrolytic solution for lithium metal battery in which the concentration of an electrolyte salt is increased (hereinafter sometimes simply referred to as “electrolytic solution”) may cause deterioration of the uniformity during manufacturing because of its high cost and poor circulation of an electrolytic solution within an electrode. However, reduction of the concentration of the electrolytic solution may cause the above problem of porosification, leading to poor safety and poor durability. The technique disclosed in Patent Document 1 mentions that the use of an electrolytic solution containing a predetermined high concentration of a lithium salt provides an optimal balance among efficiency, cycle life, conductivity, cost and viscosity. However, if the concentration of an electrolyte salt in the electrolyte solution is in the range disclosed in Patent Document 1 (for example, 4 to 6 mol of LiFSI per 1 liter of DME), not only the durability at high temperature is insufficient, but also the safety cannot be improved. Therefore, there was a need for an electrolytic solution which has a low concentration of an electrolyte in the electrolytic solution, and is excellent in safety and durability during charging/discharging.

In the light of the above problems, the present invention has been made, and an object thereof is to provide an electrolytic solution for lithium metal battery, which is capable of reducing the concentration of an electrolyte salt in an electrolytic solution and is excellent in safety and durability during charging/discharging.

(1) The present invention is directed to an electrolytic solution for lithium metal battery, including an organic solvent and an electrolyte salt,

the electrolyte salt including a lithium salt,

the organic solvent including a first organic solvent having a vapor pressure at 25° C. of 0.003 MPa or more and having no flash point, and a second organic solvent having a vapor pressure at 25° C. of 0.007 MPa or less.

According to the invention (1), it is possible to provide an electrolytic solution for lithium metal battery, which is excellent in safety of an electrolytic solution and durability during charging/discharging, by including a first organic solvent and a second organic solvent in the electrolytic solution when the concentration of the electrolyte salt in the electrolytic solution is reduced to, for example, less than 4 mol/L.

(2) The electrolytic solution for lithium metal battery according to (1), wherein the electrolyte salt includes at least one selected from the group consisting of LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂(LiFSI) and LiBC₄O₈.

According to the invention (2), it is possible to improve the safety and durability during charging/discharging of the lithium metal battery.

(3) The electrolytic solution for lithium metal battery according to (1) or (2), wherein the electrolyte salt has a concentration of 3.8 mol/L or less.

According to the invention (3), it is possible to improve the solubility of the electrolytic solution.

(4) The electrolytic solution for lithium metal battery according to any one of (1) to (3), further including an additive, wherein the additive is at least one selected from the group consisting of LiNO₃, lithium nitrite, LiPO₂F₂, Cs—PF6, PS, ES, DTD, lithium sulfate and LiFOB.

According to the invention (4), it is possible to preferably obtain the effect according to the type of additives, such as suppression of a decrease in capacity retention rate of the battery because the additive has high solubility in the electrolytic solution.

(5) The electrolytic solution for lithium metal battery according to any one of (1) to (4), wherein the electrolytic solution for lithium metal battery has a viscosity of 30 mPa·s or less.

According to the invention (5), it is possible to reduce the resistance of the battery.

(6) The electrolytic solution for lithium metal battery according to any one of (1) to (5), wherein the first organic solvent is a fluorine-substituted chain hydrocarbon.

According to the invention (6), it is possible to improve the safety of the lithium metal battery.

(7) The electrolytic solution for lithium metal battery according to any one of (1) to (6), wherein the second organic solvent includes at least one selected from the group consisting of 1,2-dimethoxyethane, 1,2-diethoxyethane and 1-ethoxy-2-(2-methoxyethoxy)ethane, and the content of the second organic solvent in the electrolytic solution for lithium metal battery is 10% by mass or more.

According to the invention (7), it is possible to improve the durability of the lithium metal battery.

(8) The electrolytic solution for lithium metal battery according to any one of (1) to (7), wherein the first organic solvent is at least one selected from the group consisting of 1,1,2,2-tetrafluoro-1-(2,2,2-trifluoroethoxy)ethane, methyl nonafluoroisobutyl ether, ethyl nonafluorobutyl ether, 1,1,1,2,3,4,4,5,5,5-decafluoro-3-methoxy-2-(trifluoromethyl)pentane, CF₃CHFCHFCF₂CF₃, CF₃CH₂CF₂CH₃, CF₃CF₂CF₂CF₂CF₂CHF₂ and CF₃CF₂CF₂CF₂CH₂CH₃.

According to the invention (8), it is possible to improve the safety of the lithium metal battery.

(9) The electrolytic solution for lithium metal battery according to any one of (1) to (8), wherein the second organic solvent includes at least one selected from the group consisting of 1,2-dimethoxyethane, 1,2-diethoxyethane and 1-ethoxy-2-(2-methoxyethoxy)ethane, and also includes at least one selected from the group consisting of ethylene carbonate, propylene carbonate, sulfolane, dimethyl carbonate, diethyl carbonate and ethyl methyl carbonate.

According to the invention (9), it is possible to improve the durability of the lithium metal battery and to improve the oxidation resistance.

(10) The electrolytic solution for lithium metal battery according to any one of (1) to (9), which has a flash point of 50° C. or higher.

According to the invention (10), it is possible to improve the safety of the lithium metal battery.

### BRIEF DESCRIPTION OF THE DRAWINGS

FIG. 1 is a graph showing the relationship between a concentration of an electrolyte salt and a viscosity of an electrolytic solution by type of an organic solvent;

FIG. 2 is a graph showing the relationship between a concentration of an electrolyte salt and a capacity retention rate by type of an organic solvent;

FIG. 3 is a graph showing the relationship between a negative electrode deposition coulombic efficiency (%) and oxidation resistance/reduction resistance when changing a mixing ratio of an organic solvent;

FIG. 4 is a graph showing the relationship between the content of an additive, and a negative electrode deposition coulombic efficiency (%) and oxidation resistance/reduction resistance;

FIG. 5 is a chart showing a reduction wave when changing the presence or absence of an additive and sweeping an electrode potential from +3 V to 0 V;

FIG. 6 is a graph showing the relationship between the number of cycles and a capacity retention rate;

FIG. 7 is a photomicrograph showing a state of a negative electrode after a cycle test of a battery in which a predetermined electrolytic solution is used;

FIG. 8 is a photomicrograph showing a state of a negative electrode after a cycle test of a battery in which a predetermined electrolytic solution is used; and

FIG. 9 is a drawing showing the solubility test results according to Examples and Comparative Examples.

### DETAILED DESCRIPTION OF THE INVENTION

### Electrolytic Solution for Lithium Metal Battery

The electrolytic solution for lithium metal battery according to the present embodiment includes an organic solvent and an electrolyte salt. The organic solvent includes at least a first organic solvent and a second organic solvent mentioned below. A flash point and a combustion point of an electrolytic solution increase by including the first organic solvent and the second organic solvent in the electrolytic solution, leading to an improvement in safety of the electrolytic solution. It is also possible to improve the durability during charging/discharging. In the electrolytic solution, additives may be included, in addition to the above.

The electrolytic solution preferably has a viscosity of 30 mPa·s or less. Thereby, the resistance of the battery can be reduced. The electrolytic solution more preferably has a viscosity of 20 mPa·s or less.

### First Organic Solvent

The first organic solvent is an organic solvent having a vapor pressure at 25° C. of 0.003 MPa or more and having no flash point. The first organic solvent is preferably a fluorine-substituted chain hydrocarbon. Specifically, the first organic solvent is preferably at least one selected from the group consisting of 1,1,2,2-tetrafluoro-1-(2,2,2-trifluoroethoxy)ethane, methyl nonafluoroisobutyl ether, ethyl nonafluorobutyl ether, 1,1,1,2,3,4,4,5,5,5-decafluoro-3-methoxy-2-(trifluoromethyl)pentane, CF₃CHFCHFCF₂CF₃ (HFC-43-10mee), CF₃CH₂CF₂CH₃ (HFC-365mfc), CF₃CF₂CF₂CF₂CF₂CHF₂ (HFC-52-13p) and CF₃CF₂CF₂CF₂CH₂CH₃ (HFC-569sf). By including the first organic solvent in the electrolytic solution, the flash point and the combustion point of the electrolytic solution can be increased, leading to an improvement in safety. By including the first organic solvent in the electrolytic solution, for example, the flash point of the electrolytic solution can be adjusted to 50° C. or higher. The content of the first organic solvent in the organic solvent is preferably 20% by mass or more, and may be 30% by mass or more.

### Second Organic Solvent

The second organic solvent is an organic solvent having a vapor pressure at 25° C. of 0.007 MPa or less. It is preferred that at least one selected from the group consisting of 1,2-dimethoxyethane (DME), 1,2-diethoxyethane and 1-ethoxy-2-(2-methoxyethoxy)ethane is included as the second organic solvent. When 1,2-dimethoxyethane is included as the second organic solvent, the content of 1,2-dimethoxyethane in the electrolytic solution is 10% by mass or more, and preferably 11% by mass or more 50% by mass or less.

It is more preferred that 1,2-dimethoxyethane (DME) is essentially included as the second organic solvent, and at least one selected from the group consisting of ethylene carbonate (EC), propylene carbonate (PC), sulfolane (SL), dimethyl carbonate (DMC), diethyl carbonate (DEC) and ethyl methyl carbonate (EMC) is also included. Namely, the second organic solvent may also be a mixed solvent of two or more solvents.

### Electrolyte Salt

The electrolyte salt is a supply source of lithium ions as a charge transfer medium, and includes a lithium salt. It is preferred that at least one selected from the group consisting of LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂(LiFSI) and LiBC₄O₈ is included as the lithium salt.

The concentration of the electrolyte salt in the electrolytic solution is preferably 3.8 mol/L or less. Thereby, it is possible to improve the durability of the battery and the circulation of the electrolytic solution within an electrode.

### Additives

Additives may be included in the electrolytic solution according to the present embodiment. It is possible to use, as the additive, known components used in the electrolytic solution for lithium metal battery, and examples thereof include a film-forming material, a dispersant and the like. Specific examples of the additive include LiNO₃, lithium nitrite, LiPO₂F₂, Cs—PF6, PS, ES, DTD, lithium sulfate, LiFOB and the like. The electrolytic solution according to the present embodiment has a low concentration of the electrolyte salt in the electrolytic solution, for example, 3.8 mol/L or less, thus enabling an improvement in solubility of the additive such as LiNO₃. The concentration of the additive in the electrolytic solution is preferably 0.01 to 5.0 mol/L.

### Lithium Metal Battery

The lithium metal battery is composed of the electrolytic solution according to the present embodiment. Specific structure of the lithium metal battery is not particularly limited, except for the electrolytic solution, and a structure used in a known lithium metal battery can be used without any limitations. As a typical one aspect, the lithium metal battery has a positive electrode layer, a negative electrode layer, and an electrolyte layer disposed between the positive electrode layer and the negative electrode layer, and the electrolyte layer can include the electrolytic solution according to the present embodiment.

### Positive Electrode Layer

The positive electrode layer is a layer including a positive electrode active material. The positive electrode active material is not particularly limited as long as it is a material which can be used as the positive electrode active material of the lithium metal battery. Examples of the positive electrode active material include a lithium-containing layered active material, a spinel type active material, an olivine type active material and the like. Specific examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), heterogeneous element-substituted Li—Mn spinel represented by Li₁+xMn₂−x−yMyO₄ (x+y=2, M=at least one selected from Al, Mg, Co, Fe, Ni and Zn), lithium titanate (oxide containing Li and Ti), lithium metal phosphate (LiMPO₄, M=at least one selected from Fe, Mn, Co and Ni) and the like.

The positive electrode layer may include a binder, a conductive aid and the like, in addition to the positive electrode active material. It is also possible to dispose a positive electrode current collector adjacent to the positive electrode layer. The positive electrode current collector is not particularly limited as long as it is a material which can be used as the positive electrode active material of the lithium metal battery.

### Negative Electrode Layer

The negative electrode layer is a layer including a negative electrode active material. It is possible to use, as the negative electrode active material, for example, lithium metal or lithium alloy alone, or a mixture thereof. Examples of the element which can form an alloy with lithium metal include Al, Mg, K, Na, Ca, Sr, Ba, Si, Ge, Sb, Pb, Sn, In, Zn and the like. It is also possible to dispose a negative electrode current collector adjacent to the negative electrode layer. The negative electrode current collector is not particularly limited as long as it is a material which can be used as the negative electrode current collector of the lithium metal battery.

### Electrolyte Layer

The electrolyte layer includes the electrolytic solution according to the above embodiment. It is possible to provide, as the electrolyte layer, a separator which can prevent short circuits between the positive electrode and the negative electrode. It is possible to use, as the separator, materials which are known as the separator of the lithium metal battery, such as a nonwoven fabric and a microporous film. The separator may be impregnated with the electrolytic solution to form an electrolyte layer.

While embodiments of the present invention have been described, the present invention is not limited to the above embodiments, and variations and improvements made within the scope of achieving the purpose of the invention are included in the present invention.

### EXAMPLES

Hereinafter, the present invention will be described in detail by way of Examples. However, the present invention is not limited to these Examples.

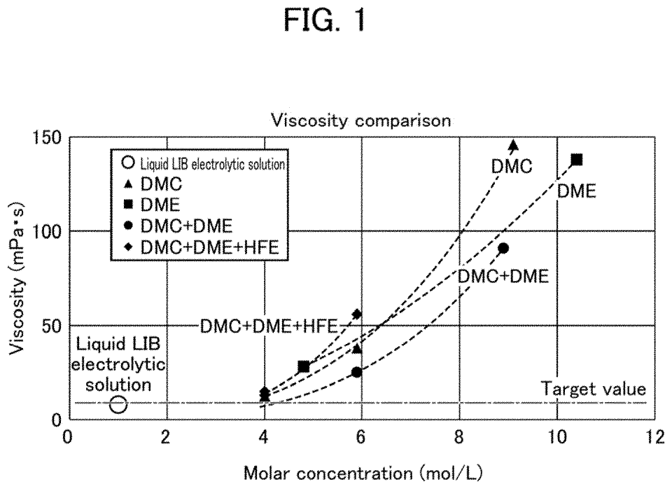

FIG. 1 is a graph showing the relationship between a concentration (mol/L) of a lithium salt (LiFSI) and a viscosity (mPa·s) of an electrolytic solution by type of an organic solvent in the electrolytic solution. In FIG. 1, “liquid LIB electrolytic solution” means an electrolytic solution for lithium ion secondary battery, and only the viscosity is shown since the viscosity of the electrolytic solution for lithium ion secondary battery is tentatively defined as the target value. In FIG. 1, “HFE” means 1,1,2,2-tetrafluoro-1-(2,2,2-trifluoroethoxy)ethane which is a first organic solvent. As shown in FIG. 1, it is apparent that when the concentration of the electrolyte salt is adjusted to, for example, 3.8 mol/L or less by mixing the first organic solvent with the second organic solvent, the viscosity equivalent to that of the electrolyte solution for lithium ion battery can be obtained. The use of the first organic solvent enables an increase in combustion point and the flash point of the electrolytic solution.

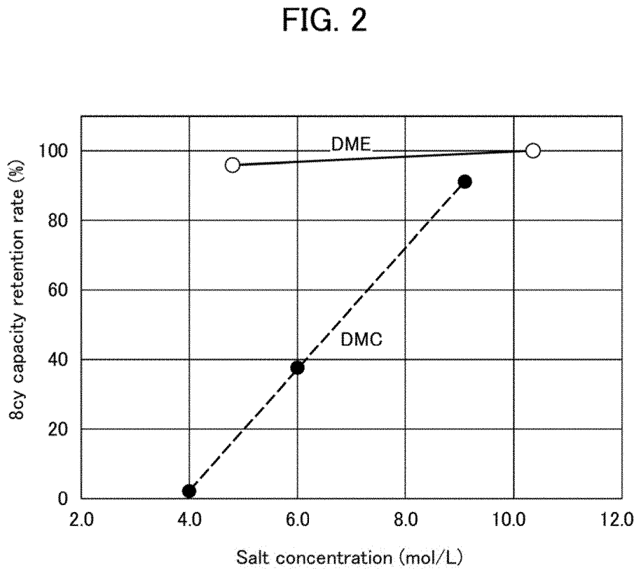

FIG. 2 is a graph showing the relationship between a concentration of an electrolyte salt and a capacity retention rate (C-rate of 0.3 C, 25° C., 0.05 MPa, 8 cycles) when each of second organic solvents DME and DMC was used alone as an organic solvent of a lithium metal battery. LiFSI was used as the electrolyte salt. The capacity retention rate was measured using a simple cell having an electrode area of 15φ. As shown in FIG. 2, it is apparent that the capacity retention rate of DME is less affected by the concentration of the electrolyte salt concentration compared to DMC.

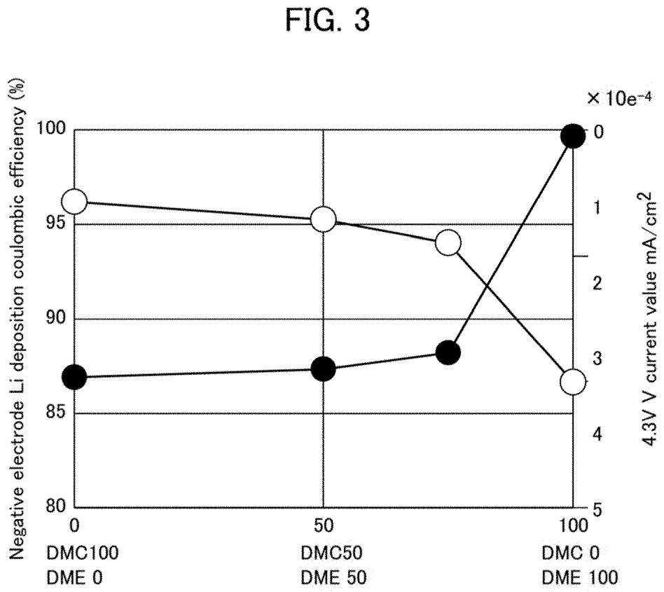

FIG. 3 is a graph showing the relationship between a negative electrode deposition Li coulombic efficiency (%) and a 4.3 V current value (mA/cm²) when a mixing ratio of each of second organic solvents DME and DMC was adjusted to 100:0, 50:50 or 0:100 in terms of a mass ratio, and each of them was used as an organic solvent of a lithium metal battery to fabricate a lithium metal battery. Li/Cu AF (25° C.) was used as the battery cell and the negative electrode Li coulombic efficiency (%) was calculated as a ratio of a discharging capacity after 10 cycles to an initial discharging capacity. LiFSI was used as the electrolyte salt and the concentration was 6 mol/L. The 4.3 V current value was a current value in the LSV measurement. In FIG. 3, a graph shown by black circle symbols indicates a negative electrode Li coulombic efficiency, and high negative electrode Li coulombic efficiency suggests that the battery is excellent in reduction resistance. A graph shown by white circle symbols indicates a 4.3 V current value. High 4.3 V current value suggests that the battery is excellent in oxidation resistance. As shown in FIG. 3, it is apparent that the oxidation resistance of the battery can be brought to the level where DMC is used alone as the organic solvent when DMC is used in a mixing ratio of 50% by mass or more.

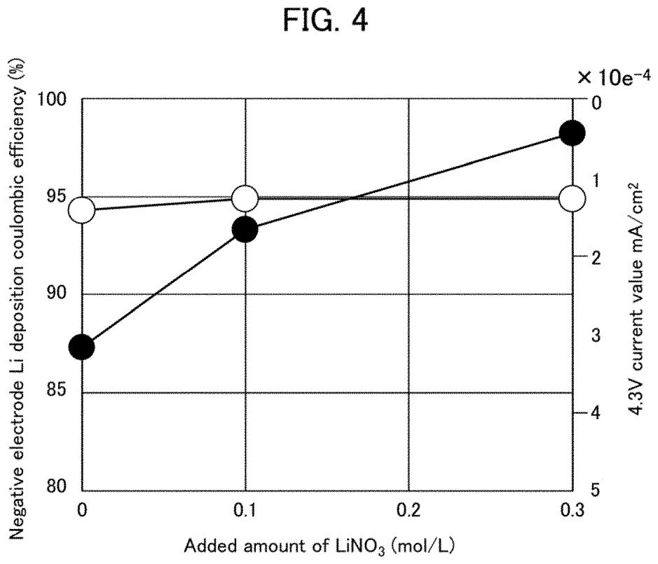

FIG. 4 is a graph showing the relationship between the added amount of LiNO₃ as an additive, and a negative electrode Li coulombic efficiency (%) and a 4.3 V current value (mA/cm²) when second solvents DME and DMC were used as the organic solvents of the lithium metal battery in a mixing ratio of 50:50 in terms of a mass ratio, and LiNO₃ was also added as an additive to fabricate a lithium metal battery. The measurement and calculation conditions of the negative electrode Li coulombic efficiency (%) and 4.3 V current value (mA/cm²) were the same as those in FIG. 3. In FIG. 4, a graph shown by black circle symbols indicates a negative electrode Li coulombic efficiency, and a graph shown by white circle symbols indicates a 4.3 V current value. As shown in FIG. 4, it is apparent that by increasing the added amount of LiNO₃, the reduction resistance can be remarkably improved while maintaining or improving the oxidation resistance of the battery.

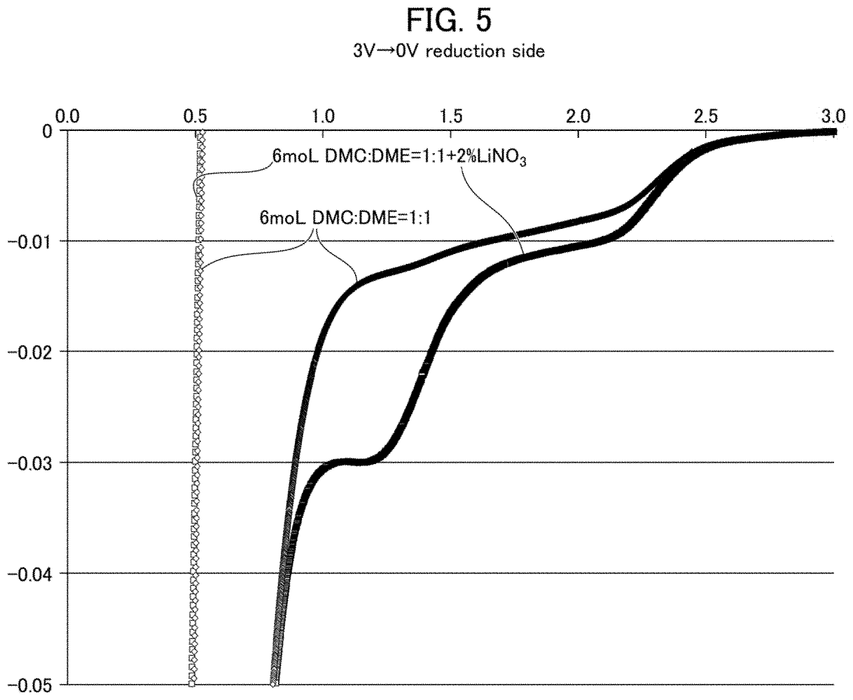

FIG. 5 is a graph showing the LSV measurement results when second solvents DME and DMC were used as the organic solvents of the lithium metal battery in a mixing ratio of 50:50 in terms of a mass ratio, and further an electrolytic solution containing 2.0% by mass of LiNO₃ added therein as the additive and an electrolytic solution containing no LiNO₃ added therein were used to fabricate a lithium metal battery. LiFSI was used as an electrolyte salt, and the concentration was 6 mol/L. Other conditions were the same as those in FIG. 3 and the like to fabricate a battery cell. In the LSV measurement, an electrode potential was swept from 3.0 V to 0 V. In the graph of FIG. 5, the horizontal axis indicates a potential (V) and the vertical axis indicates a current (mA). As shown in FIG. 5, the addition of LiNO₃ as the additive suggests high current value and acceleration of decomposition of LiFSI. Thereby, LiNO₃ coating is formed on the negative electrode and the effect of suppressing atomization due to hotspot protection is expected.

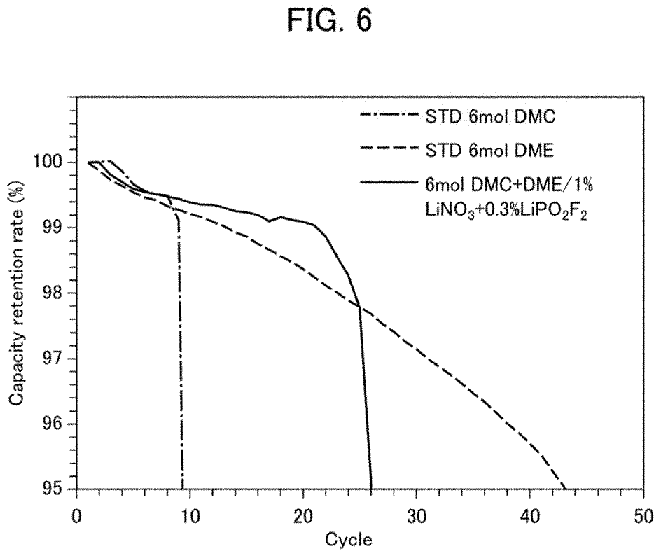

FIG. 6 is a graph showing a comparison of a capacity retention rate of a battery after a cycle test between the case where a lithium metal battery was fabricated by using each of second organic solvents DME and DMC was used alone as an organic solvent and the case where a lithium metal battery was fabricated by using DME and DMC in a mixing ratio of 50:50 in terms of a mass ratio and adding 1.0% by mass of LiNO₃ and 0.3% by mass of LiPO₂F₂ as additives. In the same manner as in FIG. 3, except that a laminate cell having an electrode area of 3×4 cm was used in a lithium metal battery, a battery cell was fabricated. The cycle test conditions were as follows: C-rate of 0.3 C, 45° C., 1 MPa. As shown in FIG. 6, when an electrolytic solution was prepared by using DME and DMC in a mixing ratio of 50:50 in terms of a mass ratio and adding 1% by mass of LiNO₃ and 0.3% by mass of LiPO₂F₂ as additives, it is apparent that reduction in capacity retention rate due to an increase in number of cycles of the battery can be suppressed compared to the electrolytic solution prepared by using each of DME and DMC alone as an organic solvent.

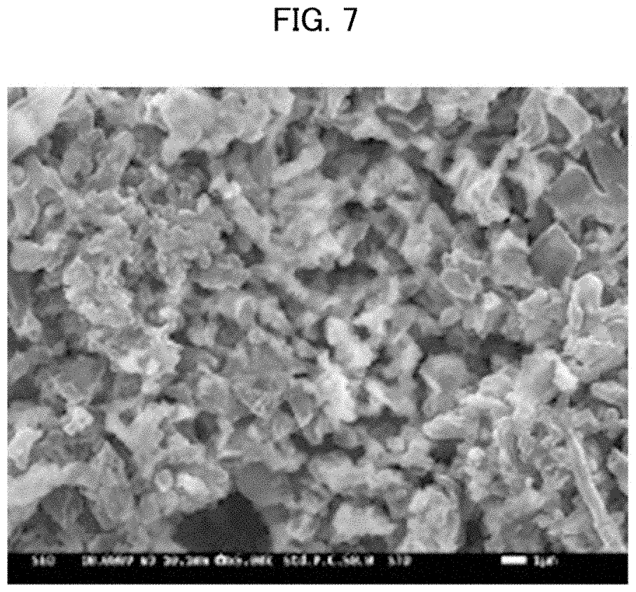

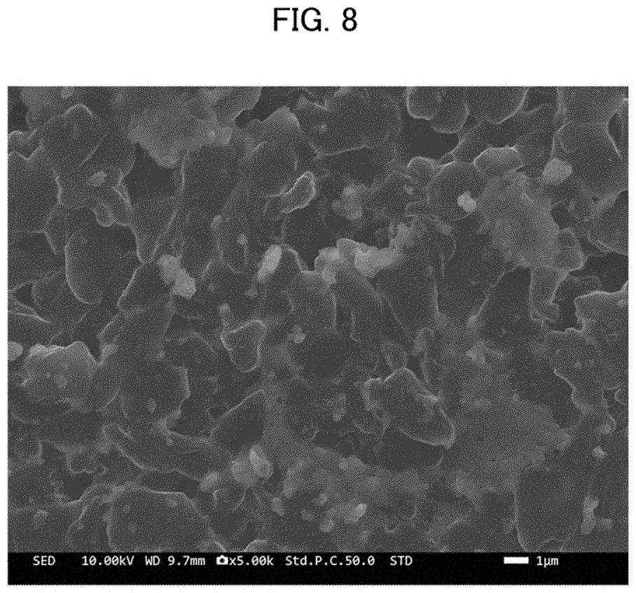

FIG. 7 is a SEM image (taken by a scanning electron microscope S-4800, manufactured by Hitachi High-Tech Corporation) of a negative electrode after a cycle test (26 cycles, SOC of 100%) in FIG. 6 of a lithium metal battery fabricated by using an electrolytic solution in which DMC was used alone as an organic solvent. FIG. 8 is a SEM image (taken by a scanning electron microscope S-4800, manufactured by Hitachi High-Tech Corporation) of a negative electrode after a cycle test (18 cycles, SOC of 100%) in FIG. 6 of a lithium metal battery fabricated by using an electrolytic solution prepared by using DME and DMC in a mixing ratio of 50:50 in terms of a mass ratio and adding 1% by mass of LiNO₃ and 0.3% by mass of LiPO₂F₂ as additives. As shown in FIG. 7 and FIG. 8, it is apparent that porosification of the negative electrode of FIG. 8 is suppressed compared to the negative electrode of FIG. 7.

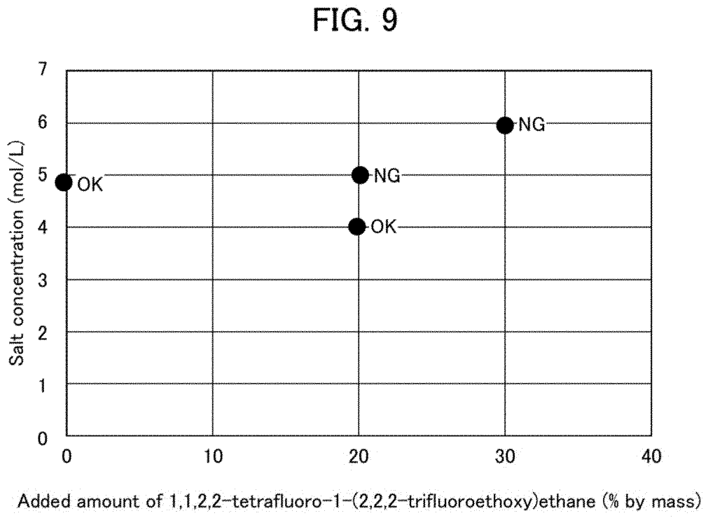

FIG. 9 is a drawing showing the solubility (good solubility: OK, poor solubility: NG) of additives (LiNO₃: 0.75%, LiPO₂F₂: 0.2%) when 1,1,2,2-tetrafluoro-1-(2,2,2-trifluoroethoxy)ethane, which is a first organic solvent, and DME, which is a second organic solvent, are used as organic solvents, and the mixing ratio of 1,1,2,2-tetrafluoro-1-(2,2,2-trifluoroethoxy)ethane and the concentration of a lithium salt (LiFSI) are changed. As shown in FIG. 9, if the concentration of the lithium salt is less than 4 mol/L, the solubility of the additive can be ensured even when the added amount of 1,1,2,2-tetrafluoro-1-(2,2,2-trifluoroethoxy)ethane is increased to about 20% by mass.

Hereinafter, electrolytic solutions according to the respective Examples and Comparative Examples of the present invention will be described.

### Preparation of Electrolytic Solution

### Example 1

As shown in Table 1, 1,1,2,2-tetrafluoro-1-(2,2,2-trifluoroethoxy)ethane as a first organic solvent, DME as a second organic solvent, LiFSI as a lithium salt, and LiNO₃ and LiPO₂F₂ as additives were mixed in each amount shown in Table 1 to prepare an electrolytic solution according to Example 1.

### Examples 2 to 4, Comparative Examples 1 to 3

In the same manner as in Example 1, except that materials constituting the electrolytic solution were changed to those shown in Table 1, electrolytic solutions according to the respective Examples and Comparative Examples were prepared.

TABLE 1

| | First organic solvent | | | Second organic solvent | | | | |
|---|---|---|---|---|---|---|---|---|
| | | Vapor | Content | Name of | Vapor | Content | Name of | Content |
| | | pressure | (% by | substance | pressure | (% by | substance | (% by |
| | Name of substance | (MPa) | mass) | (Abbreviations) | (MPa) | mass) | (Abbreviations) | mass) |
| Example 1 | 1,1,2,2-tetrafluoro-1- | 0.031 | 20 | DME | 0.006 | 38 | — | — |
| | (2,2,2- | | | | | | | |
| | trifluoroethoxy)ethane | | | | | | | |
| Example 2 | 1,1,2,2-tetrafluoro-1- | 0.031 | 10 | DME | 0.006 | 24 | DMC | 24 |
| | (2,2,2- | | | | | | | |
| | trifluoroethoxy)ethane | | | | | | | |
| Example 3 | 1,1,2,2-tetrafluoro-1- | 0.031 | 25 | DME | 0.006 | 34 | — | — |
| | (2,2,2- | | | | | | | |
| | trifluoroethoxy)ethane | | | | | | | |
| Example 4 | Ethyl nonafluorobutyl | 0.016 | 10 | DME | 0.006 | 46 | — | — |
| | ether | | | | | | | |
| Comparative | — | — | — | DME | 0.006 | 54 | — | — |
| Example 1 | | | | | | | | |
| Comparative | 1,1,1,2,2,3,3,4,4,5,5,6,6- | 0.0026 | 20 | DME | 0.006 | 26 | — | — |
| Example 2 | tridecafluorooctane | | | | | | | |
| Comparative | 1,1,1,2,2,3,3,4,4,5,5,6,6- | 0.0026 | 40 | DME | 0.006 | 10 | DMC | 10 |
| Example 3 | tridecafluorooctane | | | | | | | |

| | Lithium salt | | Additive A | Additive B |
|---|---|---|---|---|
| | Name of | | (Name of | (Name of |
| | substance | Concentration | substance/ | substance/ |
| | (Abbreviations) | (mol/L) | % by mass) | % by mass) |
| Example 1 | LiFSI | 3.8 | LiNO₃/ | LiPO₂F₂/ |
| | | | 1.00 | 0.3 |
| Example 2 | LiFSI | 3.8 | LiNO₃/ | LiPO₂F₂/ |
| | | | 1.00 | 0.3 |
| Example 3 | LiFSI | 3.9 | LiNO₃/ | — |
| | | | 1.00 | |
| Example 4 | LiFSI | 3.8 | LiNO₃/ | — |
| | | | 1.00 | |
| Comparative | LiFSI | 4 | — | — |
| Example 1 | | | | |
| Comparative | LiFSI | 6 | — | — |
| Example 2 | | | | |
| Comparative | LiFSI | 3.8 | LiNO₃/ | LiPO₂F₂/ |
| Example 3 | | | 1.00 | 0.3 |

The electrolytic solutions according to the respective Examples and Comparative Examples were evaluated and measured with respect to the following evaluation and measurement items. The results are shown in Table 2.

### Solubility Test

After weighing the electrolytic solutions of the respective Examples and Comparative Examples in a plastic container, stirring was carried out for 30 minutes using a magnetic stirrer. The appearance was observed to confirm dissolution. As a result of observation of the appearance, the electrolytic solution with good solubility was rated “OK”, and the electrolytic solution with poor solubility in appearance was rated “NG”. The evaluation results are shown in Table 2.

### Measurement of Viscosity

The viscosity of the electrolytic solutions according to the respective Examples and Comparative Examples was measured using a viscometer (digital viscometer, manufactured by BROOKFIELD). The results are shown in Table 2.

### Measurement of Flash Point

The flash point of the electrolytic solutions according to the respective Examples and Comparative Examples was measured by a Setaflash closed cup flash point tester. Each sample was placed in a closed sample cup, and after maintaining at a constant temperature for a specified time, test flame was directed into the sample cup to confirm the presence or absence of inflammation. This operation was repeated while changing the temperature to determine the lowest temperature at which the inflammation is confirmed. The results are shown in Table 2.

### Measurement of Combustion Point

The flash point of the electrolytic solutions according to the respective Examples and Comparative Examples was measured by a tag open cup flash point tester. Each sample was placed in a sample cup and then test flame was passed over the sample. The temperature at which combustion lasts for 5 seconds after the test flame passes was determined. The results are shown in Table 2.

### Fabrication of Lithium Metal Battery

Using the electrolytic solutions according to the respective Examples and Comparative Examples, lithium metal batteries according to the respective Examples and Comparative Examples were fabricated by the following procedure.

### Fabrication of Positive Electrode

Acetylene black (AB) as an electronically conductive material, polyvinylidene fluoride (PVDF) as a binder and polyvinylpyrrolidone (PVP) as a dispersant were premixed with N-methyl-2-pyrrolidone (NMP) as a dispersion solvent, and then the premixture was subjected to wet mixing using a planetary centrifugal mixer to obtain a premixed slurry. Subsequently, LiNi_{0.8}Co_{0.1}Mn_{0.1}O₂ (NCM811) as a positive electrode active material, a pre-doping agent and the premixed slurry thus obtained were mixed, and then the mixture was subjected to a dispersion treatment using a planetary mixer to obtain a positive electrode paste. NCM811 has a median size of 12 μm. An aluminum positive electrode current collector including no primer layer was coated with a positive electrode paste, followed by drying, pressurization with a roll press and further drying under vacuum at 120° C. to form a positive electrode plate including a positive electrode mixture layer. The positive electrode plate was punched out to obtain a positive electrode having a size of 30 mm×40 mm.

### Preparation of Negative Electrode

As a negative electrode, a clad material of a copper foil having a thickness of 10 μm and a lithium foil having a thickness of 20 μm was used. The clad material was punched out to obtain a negative electrode so that an electrode area had a size of 34 mm×44 mm.

### Preparation of Separator

As a separator, an alumina-coated polyethylene microporous film was used. As an electrolytic solution, those shown in Table 1 were respectively used.

### Fabrication of Lithium Metal Battery

In a bag-shaped container obtained by heat-sealing an aluminum laminate for secondary battery (manufactured by Dai Nippon Printing Co., Ltd.), a positive electrode-separator-negative electrode was introduced and then an electrolytic solution was injected to fabricate a lithium metal battery.

### Charging/Discharging Test

Using the lithium metal batteries according to the respective Examples and Comparative Examples, a charging/discharging test of the lithium metal battery was carried out. In an initial charging/discharging test, each battery was charged to 4.3 V with a C-rate of 0.1 C in a constant temperature bath at 25° C., and then discharged to 2.65 V with 0.1 C. After repeating 2 cycles, CC-CV charging was carried out in the 3rd cycle in the same manner as in the 1st cycle and the 2nd cycle, and then constant current discharging was carried out with a voltage of SOC of 50%. After 10 seconds, the voltage value was measured, and a direct current resistance value (DCR) was calculated from a slope of the current value and the voltage value after 10 seconds. The results are shown in Table 2.

### Cycle Endurance Test

Using the lithium metal batteries according to the respective Examples and Comparative Examples, a cycle endurance test was carried out by the following procedure. The lithium metal battery was charged to 4.3 V with 0.3 C in a constant temperature bath at 45° C. and then discharged to 2.65 V with 0.3 C. This cycle was repeated 50 times, and then a post-endurance test capacity retention rate was calculated by the following formula (1) assuming that the discharging current value at 0.3 C is 100. Post-endurance test capacity retention rate (%)=(cell capacity after endurance test for 50 cycles)/(initial cell capacity)×100 (1)

TABLE 2

| | | | | | Battery cell | |
|---|---|---|---|---|---|---|
| | | | | | characteristics | |
| | | | | | | 50cycle |
| | Physical properties of electrolytic solution | | | | | Capacity |
| | | | Flash | Combustion | | retention |
| | | Viscosity | point | point | DCR | rate |
| | Solubility | (mPa · s) | (° C.) | (° C.) | (Ωcm²) | (%) |
| Example 1 | OK | 18 | 100 or | 70 | 22 | 96 |
| | | | more | | | |
| Example 2 | OK | 17 | 90 | 62 | 19 | 95 |
| Example 3 | OK | 17 | 100 or | 72 | 21 | 94 |
| | | | more | | | |
| Example 4 | OK | 19 | 90 | 61 | 20 | 94 |
| Comparative | OK | 17 | 43 | 52 | 18 | 90 |
| Example 1 | | | | | | |
| Comparative | OK | 65 | 100 or | 80 | 32 | 91 |
| Example 2 | | | more | | | |
| Comparative | NG | Impossible | Impossible | Impossible | Impossible | Impossible |
| Example 3 | | to measure | to measure | to measure | to measure | to measure |

As is apparent from the results shown in Table 2, it is apparent that the lithium metal batteries fabricated using the electrolytic solutions according to the respective Examples are excellent in electrolytic solution characteristics and battery cell characteristics compared to the lithium metal batteries fabricated using the electrolytic solutions according to the respective Comparative Examples.

What is claimed is:

1. An electrolytic solution for lithium metal battery, comprising an organic solvent and an electrolyte salt,
the electrolyte salt comprising a lithium salt,
the organic solvent comprising a first organic solvent having a vapor pressure at 25° C. of 0.003 MPa or more and having no flash point, and a second organic solvent having a vapor pressure at 25° C. of 0.007 MPa or less.

2. The electrolytic solution for lithium metal battery according to claim 1, wherein the electrolyte salt comprises at least one selected from the group consisting of LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂(LiFSI) and LiBC₄O₈.

3. The electrolytic solution for lithium metal battery according to claim 1, wherein the electrolyte salt has a concentration of 3.8 mol/L or less.

4. The electrolytic solution for lithium metal battery according to claim 1, further comprising an additive, wherein the additive is at least one selected from the group consisting of LiNO₃, lithium nitrite, LiPO₂F₂, Cs—PF6, PS, ES, DTD, lithium sulfate and LiFOB.

5. The electrolytic solution for lithium metal battery according to claim 1, wherein the electrolytic solution for lithium metal battery has a viscosity of 30 mPa·s or less.

6. The electrolytic solution for lithium metal battery according to claim 1, wherein the first organic solvent is a fluorine-substituted chain hydrocarbon.

7. The electrolytic solution for lithium metal battery according to claim 1, wherein the second organic solvent comprises at least one selected from the group consisting of 1,2-dimethoxyethane, 1,2-diethoxyethane and 1-ethoxy-2-(2-methoxyethoxy)ethane, and the content of the second organic solvent in the electrolytic solution for lithium metal battery is 10% by mass or more.

8. The electrolytic solution for lithium metal battery according to claim 1, wherein the first organic solvent is at least one selected from the group consisting of 1,1,2,2-tetrafluoro-1-(2,2,2-trifluoroethoxy)ethane, methyl nonafluoroisobutyl ether, ethyl nonafluorobutyl ether, 1,1,1,2,3,4,4,5,5,5-decafluoro-3-methoxy-2-(trifluoromethyl)pentane, CF₃CHFCHFCF₂CF₃, CF₃CH₂CF₂CH₃, CF₃CF₂CF₂CF₂CF₂CHF₂ and CF₃CF₂CF₂CF₂CH₂CH₃.

9. The electrolytic solution for lithium metal battery according to claim 1, wherein the second organic solvent comprises at least one selected from the group consisting of 1,2-dimethoxyethane, 1,2-diethoxyethane and 1-ethoxy-2-(2-methoxyethoxy)ethane, and also comprises at least one selected from the group consisting of ethylene carbonate, propylene carbonate, sulfolane, dimethyl carbonate, diethyl carbonate and ethyl methyl carbonate.

10. The electrolytic solution for lithium metal battery according to claim 1, having a flash point of 50° C. or higher.
